(19) United States
(12) Patent Application Publication
(10) Pub. No.: US 2021/0074964 A1
(43) Pub. Date: Mar. 11, 2021

(54) STRAP LINKING PORTABLE ELECTRONIC DEVICE AND BATTERY PACK

(71) Applicants: Giovanni Minafò, Cento (IT); Vito Lisma, Calderara di Reno (IT)

(72) Inventors: Giovanni Minafò, Cento (IT); Vito Lisma, Calderara di Reno (IT)

(73) Assignee: Datalogic I.P. Tech S.R.L., Lippo di Calderara di Reno (IT)

(21) Appl. No.: 16/567,968

(22) Filed: Sep. 11, 2019

(51) Int. Cl. H01M 2/10

(52) U.S. Cl. CPC H01M 2/1066; H01M 2220/30

(57) ABSTRACT

A portable electronic device includes: a casing including an external surface enclosing an interior volume, a battery compartment occupying a portion of the interior volume and that opens through the external surface to form a battery opening, and a casing strap attachment point carried on the external surface; a battery pack insertable into the battery compartment through the battery opening, and to be retained within the battery compartment, wherein the battery pack comprises a battery strap attachment point; and a strap including a first end attachable to the casing strap attachment point, a second end opposite the first end, and a strap hook carried on the second end and for attachment to the battery strap attachment point to enable the battery pack to remain attached to the portable electronic device via the strap when the battery pack is not retained within the battery compartment.

### BACKGROUND OF THE INVENTION

### 1. Field of the Invention

The present invention relates to a portable electronic device incorporating a combination of a replaceable battery pack and a strap for aiding in the retention of the battery pack.

### 2. Description of the Related Art

The use of replaceable batteries incorporated into battery packs that are externally attachable to portable electronic devices is well known. Also well known is the provision of a strap attached to a portion of a casing of a portable electronic device. Such a portable electronic device may be a smart phone, an optical scanning device to scan and/or decode encoded data markings (e.g., barcodes), a portable still image and/or motion video camera, a portable radio, a portable meter or other form of measuring device or instrument, a portable patient monitoring device, a portable medication delivery device and/or any of a variety of other portable electronic devices that normally use a replaceable battery or other electrical energy storage device as a source of electric power.

Such a portable device may employ a replaceable battery pack that, when installed, is retained by the casing at a location by which a portion of the battery pack is caused to become a portion of the casing of the portable electronic device. Such replaceable battery packs may be rechargeable separately from the portable electronic device such that one of such battery packs may be installed in the portable electronic device while another is being charged at a location away from the portable electronic device. Thus, it may be deemed desirable for such battery packs to be easily “swapped” at the portable electronic device to minimize the amount of time that the portable electronic device is unable to be used as a result of not being provided with electric power by a battery pack that still carries a charge. However, as will be familiar to those skilled in the art, it is not uncommon for the act of removing a battery pack from or installing a battery pack into a portable electronic device to be a cumbersome and clumsy process in which a battery pack may all too easily be dropped onto hard flooring or other hard surfaces. As a result, such that the battery pack may be all too easily damaged such that it can no longer be used to provide electric power to the portable electronic device.

Such a portable electronic device may be sufficiently portable in its design that one or more straps are provided on the exterior of the casing thereof by which the portable device is able to be retained more securely within the grasp of one or both hands of an operator. To accommodate different sizes of hands, such straps may incorporate any of a variety of features that enable the lengthening or shortening thereof. However, as will be familiar to skilled in the art, after being lengthened, it is not uncommon for such adjustable straps to become impediments to the effective use of portable electronic devices as they fail to lie flat against the casings of portable electronic devices and/or tend to become “hooked” or “caught” on various surrounding objects that may cause the portable electronic device to actually be jerked out of the grasp of the hand(s) of an operator. Additionally, it is also not uncommon for such an adjustable strap to be positioned on the casing of a portable electronic device such that it overlies the location at which a replaceable battery pack is installed into the portable electronic device such that the strap must be lengthened to enable the strap to be moved aside to make the battery pack accessible for removal from or installation into the portable electronic device.

Thus, a solution is needed that reduces the likelihood of a replaceable battery pack of a portable electronic device being dropped during replacement, that enables a strap that has been lengthened to still lie flat against an external surface of the casing of the portable electronic device, and that does not require the length of the strap to be changed in any way to enable replacement of the replaceable battery pack.

### SUMMARY OF THE INVENTION

Disclosed herein is a strap by which a portable electronic device may be more securely retained within the grasp of one or both hands of an operator thereof, and by which a battery pack may be releasably attached to the portable electronic device to aid in enabling the replacement of the battery pack with a reduced risk of dropping and damaging it. Also disclosed herein is a portable electronic device that includes such a strap that releasably attaches a battery pack to the portable electronic device, and also disclosed herein as a battery pack that is releasably attachable to such a strap.

A portable electronic device includes a casing that includes: an external surface that at least partially encloses an interior volume; a battery compartment that occupies a portion of the interior volume and that opens through the external surface to form a battery opening; and a casing strap attachment point carried on the external surface. The portable electronic device also includes a battery pack configured to be inserted into the battery compartment through the battery opening, and to be retained within the battery compartment, wherein the battery pack comprises a battery strap attachment point. The portable device further includes a strap that includes: a first end configured to be attached to the casing strap attachment point; a second end opposite the first end; and a strap hook carried on the second end and configured to be attached to the battery strap attachment point to enable the battery pack to remain attached to the portable electronic device via the strap when the battery pack is not retained within the battery compartment.

A battery pack includes an external surface that augments an external surface of a casing of a portable electronic device to cover a battery opening of a battery compartment of the portable electronic device when the battery pack is retained within the battery compartment of the portable electronic device, wherein: the battery compartment opens through the external surface of the casing at the battery opening; and the battery compartment extends into and occupies a portion of an interior volume enclosed by the casing. The battery pack also includes a battery strap attachment point configured to be attached to a strap hook of a strap, wherein: the strap comprises a first end configured to be attached to a casing strap attachment point carried on the external surface of the casing; and the strap hook is attached to a second end of the strap that is opposite the first end to enable the battery pack to remain attached to the portable electronic device through via the strap when the battery pack is not retained within the battery compartment.

### BRIEF DESCRIPTION OF THE DRAWINGS

FIGS. 1A, 1B, 1C and 1D, together, show aspects of an example portable electronic device incorporating an example combination of strap and battery pack.

FIGS. 2A, 2B, 2C, 2D and 2E, together, show aspects of an example implementation of the strap of FIGS. 1A-D.

FIGS. 3A, 3B and 3C, together, show aspects of an example implementation of the battery pack of FIGS. 1A-D.

### DETAILED DESCRIPTION OF THE INVENTION

In the following detailed description, reference is made to the accompanying drawings that form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Disclosed herein is a strap by which a portable electronic device may be more securely retained within the grasp of one or both hands of an operator thereof, and by which a battery pack may be releasably attached to the portable electronic device to aid in enabling the replacement of the battery pack with a reduced risk of dropping and damaging it. Also disclosed herein is a portable electronic device that includes such a strap that releasably attaches a battery pack to the portable electronic device, and also disclosed herein as a battery pack that is releasably attachable to such a strap.

A portable electronic device includes a casing that includes: an external surface that at least partially encloses an interior volume; a battery compartment that occupies a portion of the interior volume and that opens through the external surface to form a battery opening; and a casing strap attachment point carried on the external surface. The portable electronic device also includes a battery pack configured to be inserted into the battery compartment through the battery opening, and to be retained within the battery compartment, wherein the battery pack comprises a battery strap attachment point. The portable device further includes a strap that includes: a first end configured to be attached to the casing strap attachment point; a second end opposite the first end; and a strap hook carried on the second end and configured to be attached to the battery strap attachment point to enable the battery pack to remain attached to the portable electronic device via the strap when the battery pack is not retained within the battery compartment.

An external surface of the battery pack may augment the external surface of the casing to cover the battery opening when the battery pack is retained within the battery compartment.

The portable electronic device may include a handheld electronic device; the external surface of the casing may form part of a hand grip portion of the casing that is surrounded by a hand when the portable electronic device is gripped by the hand; and when the battery pack is retained within the battery compartment, the casing strap attachment point and the battery strap attachment point may be positioned to cause the strap to extend crosswise over the hand grip portion to enable the hand to be inserted between the hand grip portion and the strap to aid in securing the portable electronic device to the hand.

The strap hook may be detachable from the battery strap attachment point when the battery pack is not retained within the battery compartment to enable the battery pack to be exchanged for another battery pack for use with the portable electronic device; the battery compartment may include a sidewall that intersects a portion of the external surface of the casing along a portion of an edge of the battery opening, and extends inward into the interior volume of the casing in an orientation that causes the sidewall to extend parallel to another surface of the battery pack when the battery pack is retained within the battery compartment; the battery strap attachment point may be positioned on a portion of the other surface of the battery pack that causes the battery strap attachment point to be positioned between the other surface of the battery pack and the sidewall of the battery compartment when the battery pack is retained within the battery compartment; and the battery strap attachment point may be configured to cooperate with the sidewall of the battery compartment to surround the strap hook to keep the strap hook from being detached from the battery strap attachment point when the battery pack is retained within the battery compartment.

The strap hook may include a pair of tabs; the battery strap attachment point may include a pair of apertures that are each formed through one of a pair of opposed surfaces of the battery pack to enable each aperture to receive a corresponding tab of the pair of tabs of the strap hook; and each tab of the pair of tabs and each aperture of the pair of apertures may be configured to cooperate to form a pair of hinges that enable the strap hook to rotate relative to the battery pack.

Each aperture of the pair of apertures may be positioned at one of a pair of adjacent corners of the battery pack.

The strap hook may have a generally U-shaped configuration with each tab of the pair of tabs positioned at one of the ends of the U-shape in an orientation that causes the pair of tabs to extend toward each other; at least a portion of the strap hook may include a flexible material that enables the U-shape to be flexed to cause the pair of tabs to be spread further apart from each other; and the battery pack may include a pair of chamfer surfaces with each chamfer surface of the pair of chamfer surfaces positioned adjacent one of the apertures of the pair of apertures to cooperate with portions of the ends of the U-shape of the strap hook to spread the pair of tabs further apart from each other when the strap hook is rotated relative to the battery pack to cause the ends of the U-shape to engage the pair of chamfer surfaces.

The strap hook may be formed as a single piece of plastics material that is selected to enable the U-shape to be flexed to cause the pair of tabs to be spread further apart from each other.

The strap may include a first patch and a second patch of a selected one of hook fasteners and loop fasteners positioned on opposite sides of the first end; the strap may include a third patch of the non-selected one of hook fasteners and loop fasteners positioned toward the second end; the first end may be configured to loop through the casing strap attachment point and extend back over second end to position either the first patch or the second patch adjacent to and facing the third patch to enable engagement of the hook fasteners and the loop fasteners therebetween; and the strap may be able to be lengthened or shortened by selectively positioning one of the first patch and the second patch adjacent to and facing the third patch.

The strap hook may cooperate with the battery strap attachment point to form a hinge that enables the strap hook to rotate relative to the battery pack and relative to the external surface of the casing when the battery pack is retained within the battery compartment to enable the strap to be positioned to extend flat against the external surface of the casing regardless of whether the strap is lengthened or shortened.

The casing strap attachment point may include a hinged component that rotates relative to the external surface of the casing to also enable the strap to be positioned to extend flat against the external surface of the casing regardless of whether the strap is lengthened or shortened.

A battery pack includes an external surface that augments an external surface of a casing of a portable electronic device to cover a battery opening of a battery compartment of the portable electronic device when the battery pack is retained within the battery compartment of the portable electronic device, wherein: the battery compartment opens through the external surface of the casing at the battery opening; and the battery compartment extends into and occupies a portion of an interior volume enclosed by the casing. The battery pack also includes a battery strap attachment point configured to be attached to a strap hook of a strap, wherein: the strap comprises a first end configured to be attached to a casing strap attachment point carried on the external surface of the casing; and the strap hook is attached to a second end of the strap that is opposite the first end to enable the battery pack to remain attached to the portable electronic device through via the strap when the battery pack is not retained within the battery compartment.

The battery pack may further include: at least one finger-operable retention hook configured to cooperate with at least one mating retention hook within the battery compartment to retain the battery pack within the battery compartment while the finger-operable retention hook is not operated to release the battery pack from the battery compartment; and at least one fixed retention hook configured to cooperate with at least one other mating retention hook within the battery compartment to retain the battery pack within the battery compartment while the finger-operable retention hook is not operated to release the battery pack from the battery compartment.

The battery pack may be of generally elongate shape and the finger-operable retention hook and the battery strap attachment point are both positioned at one end of the elongate shape.

The external surface of the battery pack may cooperate with at least a portion of the external surface of the casing to form part of a hand grip portion of the casing that is surrounded by a hand when the battery pack is retained within the battery compartment and the portable electronic device is gripped by the hand; and when the battery pack is retained within the battery compartment, the casing strap attachment point and the battery strap attachment point may be positioned to cause the strap to extend crosswise over the hand grip portion to enable the hand to be inserted between the hand grip portion and the strap to aid in securing the portable electronic device to the hand.

The strap hook may be detachable from the battery strap attachment point when the battery pack is not retained within the battery compartment to enable the battery pack to be exchanged for another battery pack for use with the portable electronic device; the battery compartment may include a sidewall that intersects a portion of the external surface of the casing along a portion of an edge of the battery opening, and extends inward into the interior volume of the casing in an orientation that causes the sidewall to extend parallel to a another surface of the battery pack when the battery pack is retained within the battery compartment; the battery strap attachment point may be positioned on a portion of the other surface of the battery pack that causes the battery strap attachment point to be positioned between the other surface of the battery pack and the sidewall of the battery compartment when the battery pack is retained within the battery compartment; and the battery strap attachment point may be configured to cooperate with the sidewall of the battery compartment to surround the strap hook to keep the strap hook from being detached from the battery strap attachment point when the battery pack is retained within the battery compartment.

The strap hook may include a pair of tabs; the battery strap attachment point may include a pair of apertures that are each formed through one of a pair of opposed surfaces of the battery pack to enable each aperture to receive a corresponding tab of the pair of tabs of the strap hook; and each tab of the pair of tabs and each aperture of the pair of apertures may be configured to cooperate to form a pair of hinges that enable the strap hook to rotate relative to the battery pack.

Each aperture of the pair of apertures may be positioned at one of a pair of adjacent corners of the battery pack.

The strap hook may have a generally U-shaped configuration with each tab of the pair of tabs positioned at one of the ends of the U-shape in an orientation that causes the pair of tabs to extend toward each other; at least a portion of the strap hook may include a flexible material that enables the U-shape to be flexed to cause the pair of tabs to be spread further apart from each other; and the battery pack may include a pair of chamfer surfaces with each chamfer surface of the pair of chamfer surfaces positioned adjacent one of the apertures of the pair of apertures to cooperate with portions of the ends of the U-shape of the strap hook to spread the pair of tabs further apart from each other when the strap hook is rotated relative to the battery pack to cause the ends of the U-shape to engage the pair of chamfer surfaces.

The strap hook may cooperate with the battery strap attachment point to form a hinge that enables the strap hook to rotate relative to the battery pack and relative to the external surface of the casing when the battery pack is retained within the battery compartment to enable the strap to be positioned to extend flat against the external surface of the casing when the strap is lengthened.

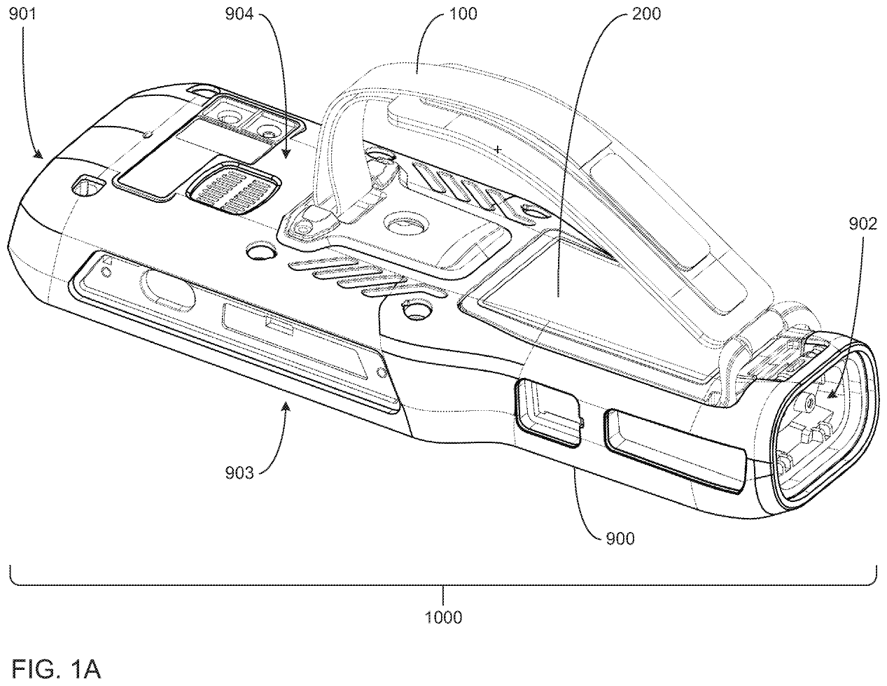

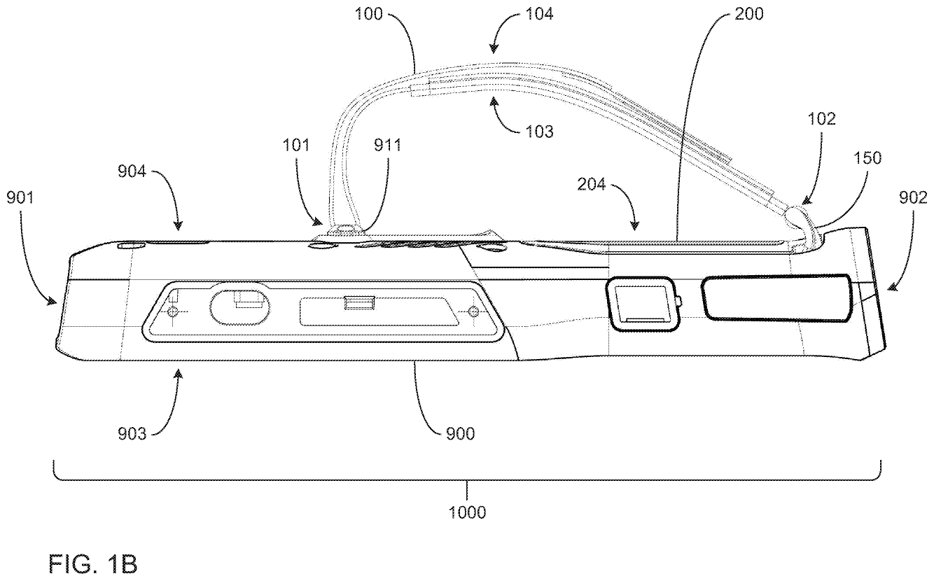

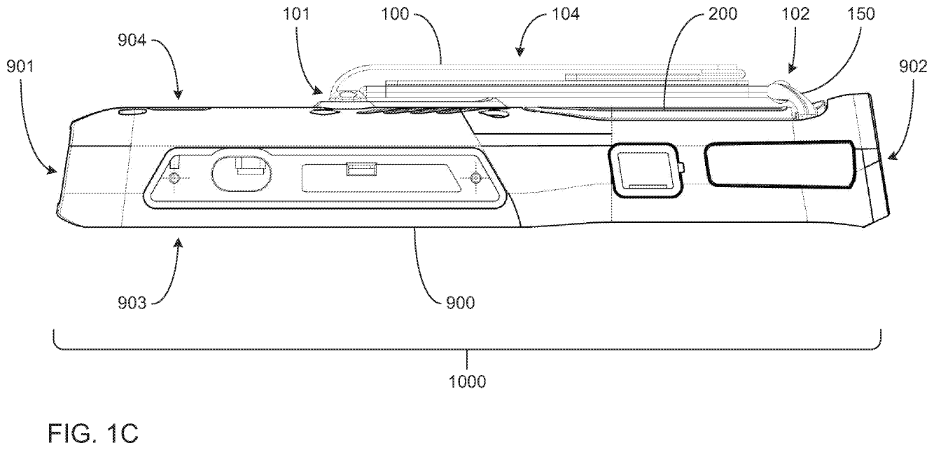

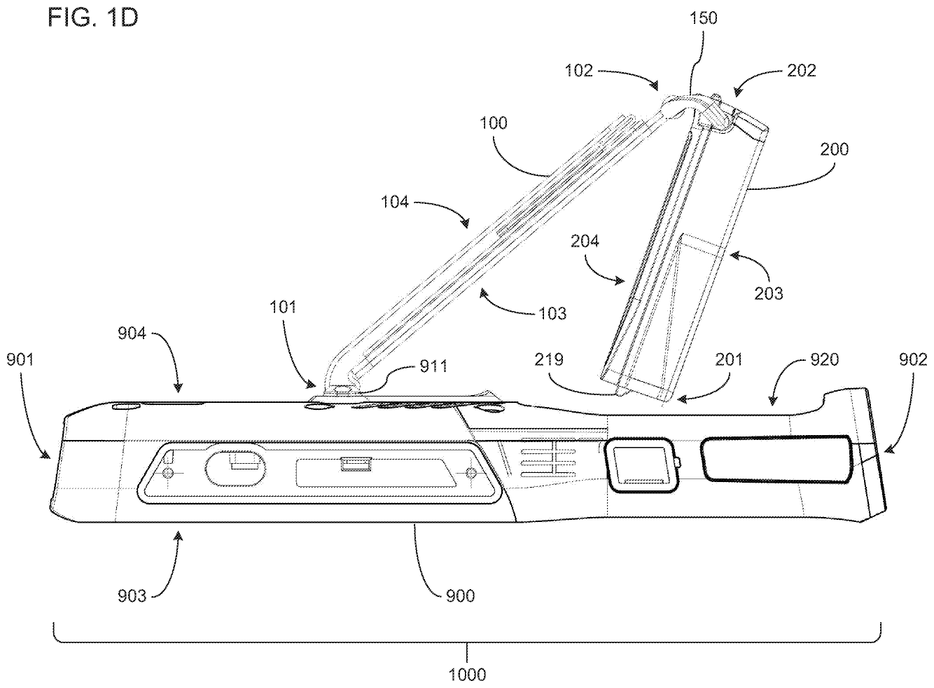

FIGS. 1A through 1D, together, depict aspects of an example embodiment of a portable electronic device 1000 having a casing 900, and incorporating a strap 100 and a replaceable battery pack 200. The casing 900 may have a front end 901, a back end 902 opposite the front end 901, a top surface 903 that extends between the front end 901 and back end 902, and a bottom surface 904 opposite the top surface 903. As depicted, the casing 900 may be of a shape and size that enables the portable electronic device 1000 to be grasped and held with a single hand. As more specifically depicted, the portable electronic device 1000 may be handheld barcode scanner incorporating an optical reader within the front end 901 for scanning one-dimensional and/or two-dimensional encoded data markings (e.g., barcodes, QR codes and/or digital watermarks).

However, it should be noted that the depiction herein of such a particular size and shape of the casing 900 is by way of example, only, and should not be taken as limiting. Also, it should be noted that the depiction herein of such a particular type of portable electronic device as the portable electronic device 1000 is also by way of example, only, and also should not be taken as limiting. Stated differently, the portable electronic device 1000 may any of a variety of types, including and not limited to, a smart phone, a portable still image and/or motion video camera, a portable radio, a portable meter or other form of measuring device or instrument, a portable patient monitoring device, a portable medication delivery device, etc.

Regardless of what type of device the portable electronic device 1000 is, and as is most clearly depicted in FIG. 1D, a battery compartment 920 to retain the battery pack 200 to provide electric power to portable electronic device 1000 may be formed into the bottom surface 904 of the casing 900. As is most clearly depicted most clearly in FIG. 1A, the back end 902 of the casing 900 may incorporate a charging connection point by which the portable electronic device 1000 may be connected to a charging device (not shown) by which the battery pack 200 may be recharged while still installed within the battery compartment 920 of the portable electronic device 1000. Alternatively or additionally, the connection point at the back end 902 of the casing 900 may enable the portable electronic device 1000 to be operated to perform its function(s) using electrical power supplied by an external power source (e.g., via a power cord).

Not unlike the casing 900, battery pack 200 may also have a front end 201 and a back end 202 opposite the front end 201, a top surface 203 that extends between the front end 201 and back end 202, and a bottom surface 204 opposite the top surface 203. As depicted, when the battery pack 200 is installed within the battery compartment 920, the bottom surface 204 of the battery pack 200 is caused to form part of the bottom surface 904 of the casing, and the orientation of the battery pack 200 becomes such that the front ends 901 and 201, and the bottom ends 902 and 202 of the casing 900 and the battery pack 200, respectively, are caused to be aligned.

The battery pack 200 may incorporate one or more batteries, one or more super capacitors, and/or one or more other energy storage components based on any of a variety of technologies used to provide electrical power to support the operation of the portable electronic device 1000. As will be familiar to those skilled in the art, the type and/or quantity of energy storage components selected for use within the battery pack 200 may be at least partially based on the expected electrical power requirements (e.g., amperage(s) and/or voltage(s)) of the portable electronic device 1000. As will also be familiar to those skilled in the art, various limitations of the energy storage components that are selected for use may necessitate interconnecting multiple ones of those energy storage components in series (e.g., to achieve a particular voltage output level), in parallel (e.g., to achieve amount particular current capacity), and/or a combination of both.

The casing 900 and at least the bottom surface 204 of the battery pack 200 may be formed from any of a variety of materials, including and not limited to, any of a variety of plastics material(s), any of a variety of metallic material(s), any of a variety of ceramic material(s), and/or any of a variety of rubberized material(s). The selection of the one or more materials so used may be based on the environmental conditions in which the portable electronic device 1000 is to be used, including and not limited to, expected ranges of temperature, expected levels of humidity, expected exposure to dust or debris, expected exposure to water and/or other liquids, etc. In some embodiments, the selection of the one or more materials so used may be to enable the dissipation of heat generated from within the portable electronic device 1000 and/or may be to meet one or more specific industry standards for impact resistance, reduction in risk of generating sparks and/or other considerations.

Not unlike the casing 900 and the battery pack 200, the strap 100 may also have a front end 101 and a back end 102 opposite the front end 101, a top surface 103 that extends between the front end 101 and back end 102, and a bottom surface 104 opposite the top surface 103. As more clearly depicted and indicated in FIGS. 1B and 1D, a strap attachment point 911 may be formed on or otherwise carried on the bottom surface 904 of the casing 900 to provide a location to which the front end 101 of the strap 100 may be attached. As more clearly depicted and indicated in FIG. 1D, a hook 150 may be rotatably carried on the back end 202 of the battery pack 200 to provide a battery strap attachment point to which the back end 102 of the strap 100 may be attached. Thus, as depicted more clearly in FIG. 1D, each end 101 and 102 of the strap 100 may be attached to a different one of the casing 900 and the battery pack 200, respectively. As will be explained in greater detail, this may serve as an aid to avoiding instances of the battery pack 200 being dropped onto a hard floor surface and/or other hard surface during replacement of the battery pack 200.

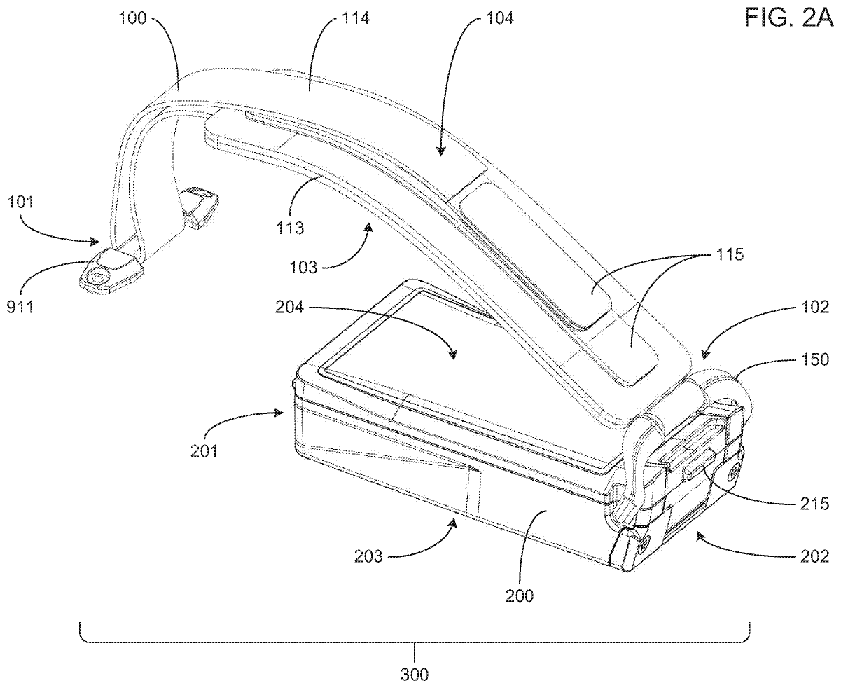

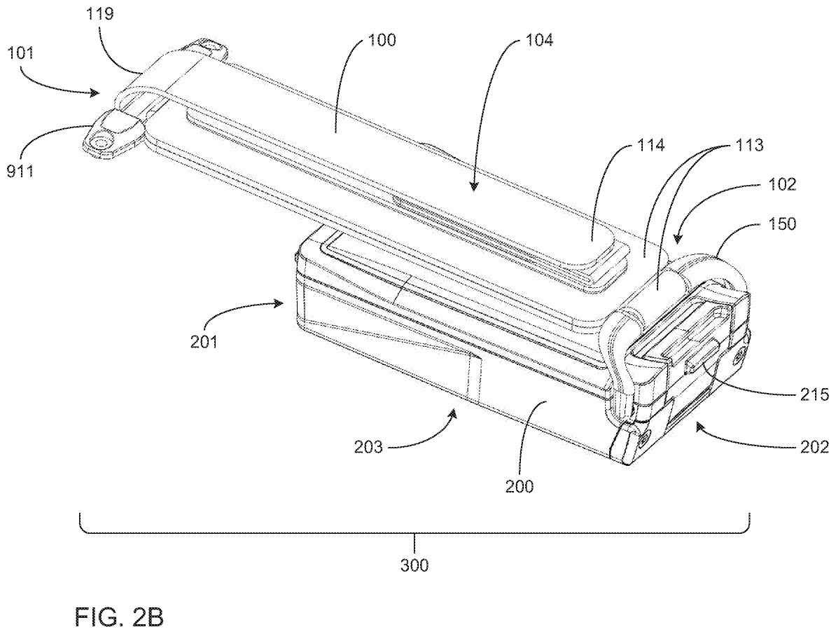

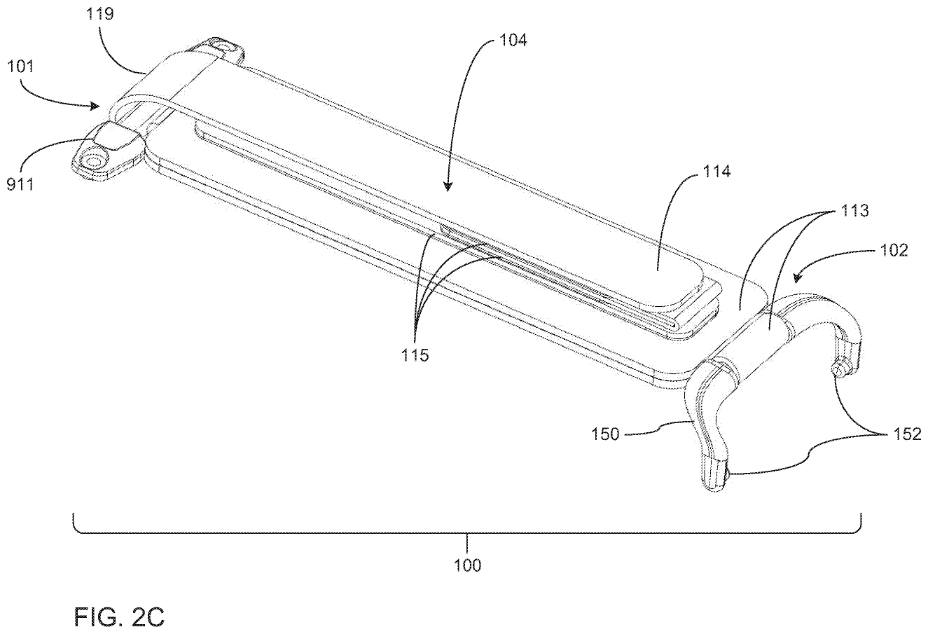

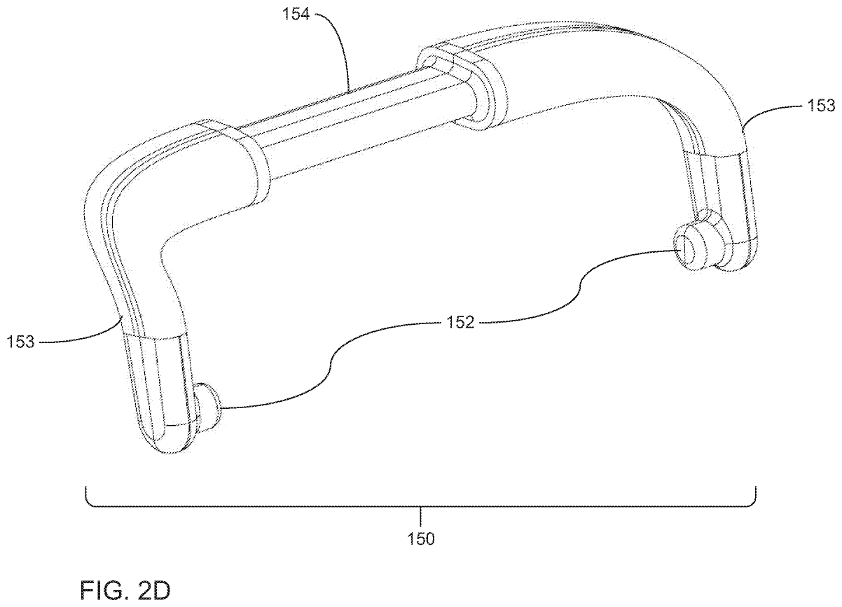

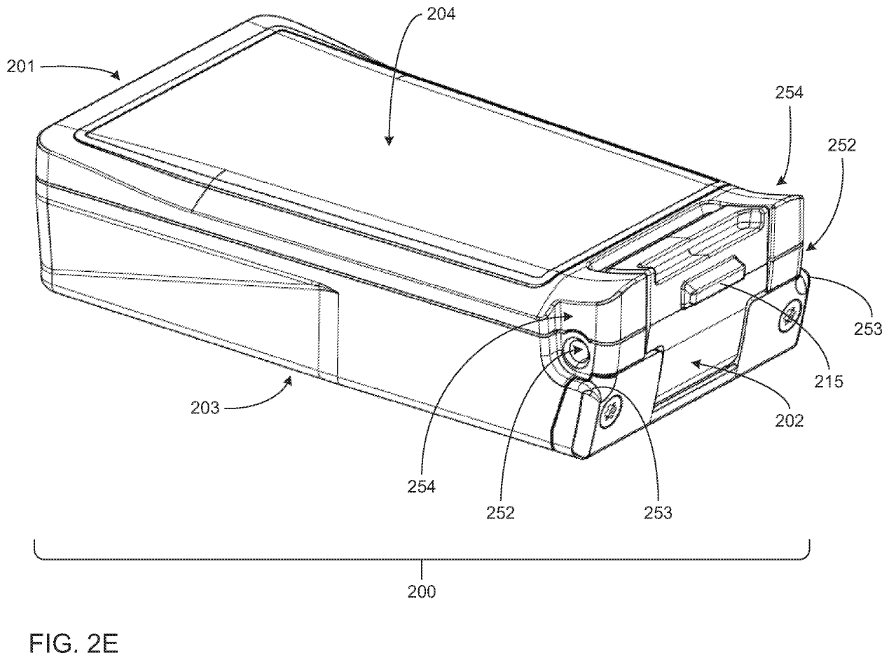

FIGS. 2A through 2E, together, depict aspects of an example embodiment of the strap 100. More specifically, FIGS. 2A-E depict aspects of the manner in which the strap 100 may be lengthened and/or shortened, including aspects of the manner in which the strap 100 is attached to the battery pack 200.

As depicted more clearly in FIGS. 2A-C, the strap 100 may be formed from strapping material with one portion 113 that is attached to and extends from the 150 at the bottom end 102 to the strap attachment point 911, where the strapping material forms a loop 119 through the strap attachment point 911 to define the top end 101, and from which the other portion 114 of the strapping material extends back toward (but doesn't quite reach) the hook 150 at the top end 101. As also depicted, each of the portions 113 and 114 may carry one or more patches 115 of hook and/or loop material that may enable the portions 113 and 114 to be releasably attached to each other at various points along their lengths in a manner that allows the overall length of the strap 100 to be adjustable. More precisely, and as most clearly set forth by contrasting what is depicted among FIGS. 2A-C, both sides of the end of the portion 114 may carry patches 115 of hook and/or loop material to enable either side to become releasably attached to the portion 113. Thus, the end of the portion 114 may be folded over itself (as depicted in FIGS. 2B-C) to reduce the overall length of the strap 100, or the end of the portion 114 fully extended (as depicted in FIG. 2A) to increase the overall length of the strap 100.

As depicted more clearly in FIGS. 2C-E, the hook 150 has a generally U-shaped configuration defined by a central portion 154 connecting a pair of curving arm portions 153 that each carries one of a pair of tabs 152. As more broadly depicted herein, including in FIGS. 2A-E, each one of the pair of tabs 152 extend into a corresponding one of a pair of apertures 252 formed in one of a pair of corner regions 254 of the battery pack at opposite ends of the edge between the back end 202 and the bottom surface 204. The pair of tabs 152 cooperates with the apertures 252 to form a hinge by which the hook 150 is able to be rotated about the pair of corner regions 254. Each of the corner regions 254 is inset into the otherwise box-like shape of the battery pack 200, and is shaped and sized to interact with a corresponding one of the arm portions 153 of the hook 150 in a manner that limits the range of motion of this hinge-like rotation.

As depicted more clearly in FIGS. 2A-D, the end of the portion 113 of strapping material at the bottom end 102 of the strap 100 may wrap around the central portion 154 of the hook 150, thereby forming another hinge involving the hook 150. The pair of hinged connections thus formed between the hook 150 and the corner regions 254 of the battery pack 200, and between the hook 150 and the portion 113 of at the bottom end 102 may enable the front surface 103 of the strap 100 to remain capable of lying flat against the bottom surface 904 of the casing 900 (including the portion of the bottom surface 904 that is provided by the bottom surface 204 of the battery pack 200 when the battery pack 200 is installed within the battery compartment 920) after the end of the portion 114 has been unfolded and extended (as depicted in FIG. 2A) to lengthen the strap 100.

The strap 100 (including the portions 113 and 114 thereof) may be made from any of a variety of flexible materials, including and not limited to, flexible plastics material(s), rubber and/or other types of rubberized material(s), portion(s) of leather and/or other forms of animal hide, woven natural plant and/or synthetic fibers, metallic foil material(s), etc. The patches 115 of hook and/or loop fasteners may attached to the portions 113 and/or 114 of the strap 100 via stitching, heat bonding, adhesive(s), etc.

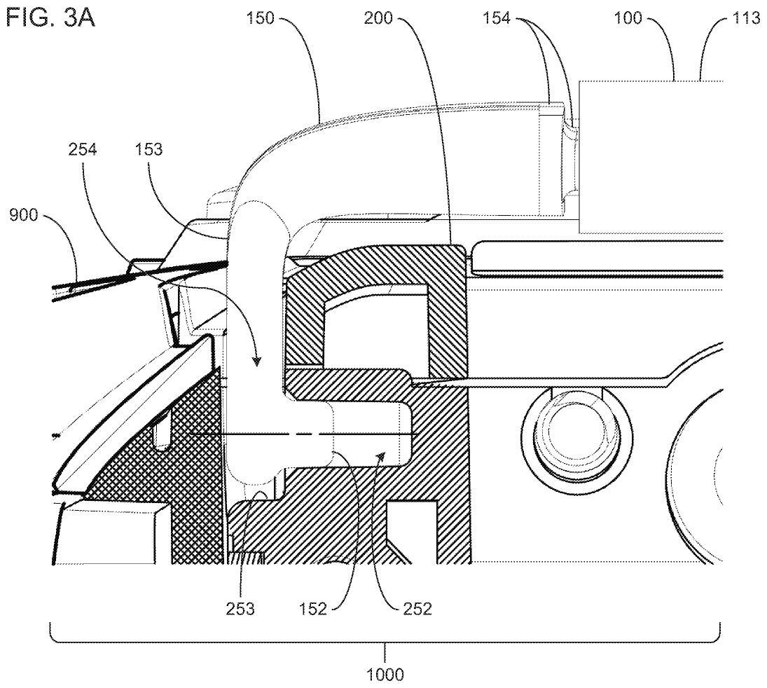

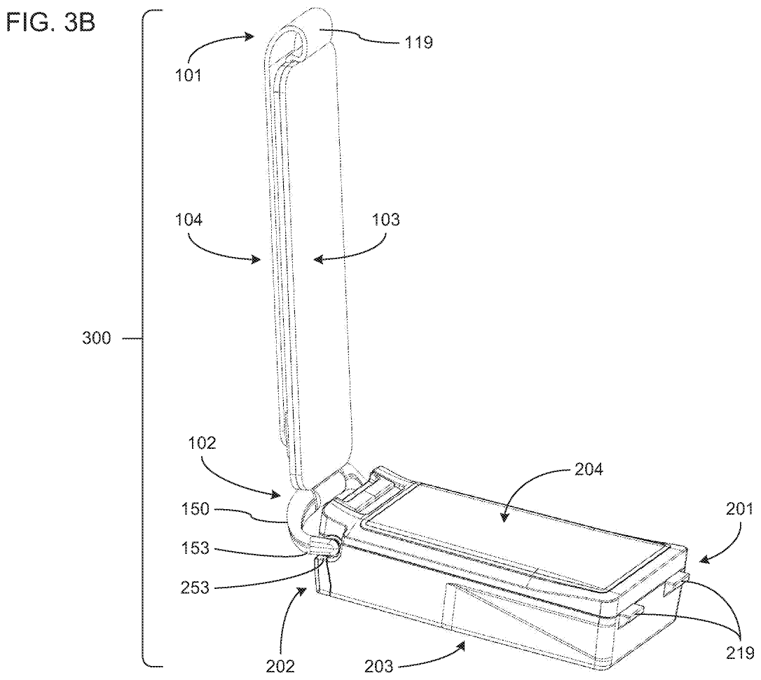

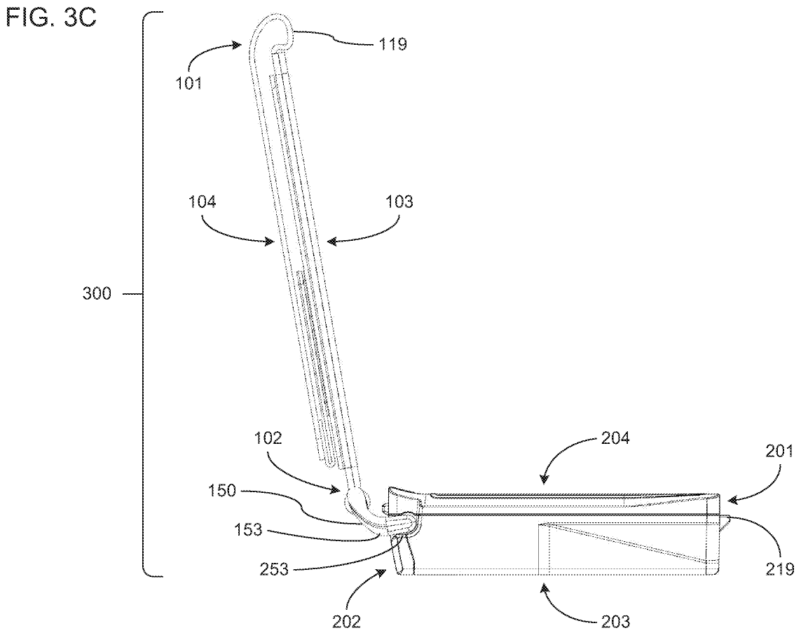

FIGS. 3A through 3C, together, depict aspects of an example embodiment of the battery pack 200. More specifically, FIGS. 3A-C depict aspects of the manner in which the battery pack 200 may be installed into or removed from the battery compartment 920 of the portable electronic device 900, including aspects of the manner in which the battery pack 200 may be attached to or detached from the strap 100.

As depicted more clearly in FIG. 3A, with the tabs 152 carried by the curved arms 153 of the hook 150 inserted into corresponding ones of the apertures 252 at the corner regions 254 of the battery pack 200, and with the battery pack 200 installed within the battery compartment 920 such that the bottom surface 204 of the battery pack 200 provides a portion of the bottom surface 904 of the casing, each of the arms 153 of the hook 150 becomes constrained in its movement such that neither of the tabs 152 are able to be removed from its corresponding aperture 252. More specifically, portions of the casing 900 that define sidewalls of the battery compartment 920 near the corner regions 254 serve to so constrain the movement of the arms 153 when the battery pack 200 is installed therein. To be clear, the arms 153 are still able to move in the aforementioned hinge-like manner defined by the interaction between the pair of tabs 152 and the pair apertures 252. In this way, with the battery pack 200 installed into the portable electronic device 1000, the hook 150 cannot be detached from the battery pack 200 such that the strap 100 remains connected via the hook 150 to the battery pack 200.

However, as depicted more clearly in FIGS. 3B-C, with the battery pack 200 removed from the battery compartment 920, the pair of arms 153 are not so constrained such that they may be pulled further apart from each other such that the pair of tabs 152 may be removed from their hinge-like engagement with the pair apertures 252. As depicted in FIGS. 3B-C and in FIG. 2E, the inset shape of each of the pair of corner regions 254 of the battery pack 200 is partly defined by a corresponding one of a pair of chamfer surfaces 253. Each of the chamfer surfaces 253 is shaped and positioned to provide a form of “ramp” that may be used to cause such further spreading apart of the pair of arms 153 of the hook 150 by using the hinge-like engagement between the pair of tabs 152 and the pair of apertures 252 to rotate the hook 150 so that the pair of arms 153 are caused to engage corresponding ones of the pair of chamfer surfaces 253. In this way, the strap 100 is made relatively easily detachable from the battery pack 200 as part of enabling the replacement of one battery pack 200 with another.

In some embodiments, the entirety of the hook 150 may be made of a material selected to combine stiffness with a selected degree of flexibility to cause the pair of tabs 152 to tend to remain inserted within the pair of apertures 252. However, such a material may also be selected to still have sufficient flexibility to allow the aforedescribed engagement between the pair of curved arms 153 and the pair of chamfer surfaces 253 to cause the pair of arms 153 to be further spread apart enough to allow the removal of the pair of tabs 152 from the pair of apertures 252. In other embodiments, it may be that the pair of arms 153 is made of a relatively stiff material that affords little or no flexibility, while the central portion 154 of the hook 150 is formed of a more flexible material selected to enable such an engagement between the curved arms 153 and the pair of chamfer surfaces 253.

As depicted most clearly in FIGS. 3B-C, the top end 201 of the battery pack 200 may carry one or more tabs 219 by which the battery pack 200 may be retained within the battery compartment 920. Similarly, and as depicted most clearly in FIGS. 2A-B and 2E, the bottom end 202 of the battery pack 200 may carry one or more tabs 215 by which the battery pack 200 may be retained within the battery compartment 920, in addition to or in lieu of the one or more tabs 219.

As depicted most clearly in FIG. 1D, in some embodiments, the manner in which the battery pack 200 may be inserted into the battery compartment 920 may entail first inserting the top end 201 into the battery compartment 920, followed by pivoting the bottom end 202 into the battery compartment 920. Correspondingly, in such embodiments, removal of the battery pack 200 from the battery compartment may entail pivoting the bottom end 202 of the battery pack 200 out of the battery compartment 920, followed by removing the top end 201 from the battery compartment 200. Such pivoting of the bottom end 202 may rely on an engagement between the one or more tabs 219 at the top end 201 of the battery pack 200 engaging a portion of the casing (e.g., a sidewall of the battery compartment 920) in a hinge-like manner. In some of such embodiments, a finger-operable retention hook (not shown) may be formed into the casing 900 adjacent the battery compartment 920 to engage the one or more tabs 215 at the bottom end of the battery pack 200 to enable the battery pack 200 to be retained therein in a manner that is releasable by manual operation thereof. Alternatively, in others of such embodiments, a finger-operable retention hook (also not shown) may be formed in the bottom end 202 of the battery pack 200 to engage a portion of the casing 900 (e.g., a portion of a sidewall of the battery compartment 920) to enable the battery pack 200 to be similarly releasably retained within the battery compartment 920.

There is thus disclosed a portable electronic device incorporating a combination of a replaceable battery pack and a strap for aiding in the retention of the battery pack. The features set forth below may be combined in any of a variety of ways to create any of a variety of embodiments of a decoding device, a decoding system and/or a method of decoding data encoded within encoded data markings.

A portable electronic device includes a casing that includes: an external surface that at least partially encloses an interior volume; a battery compartment that occupies a portion of the interior volume and that opens through the external surface to form a battery opening; and a casing strap attachment point carried on the external surface. The portable electronic device also includes a battery pack configured to be inserted into the battery compartment through the battery opening, and to be retained within the battery compartment, wherein the battery pack comprises a battery strap attachment point. The portable device further includes a strap that includes: a first end configured to be attached to the casing strap attachment point; a second end opposite the first end; and a strap hook carried on the second end and configured to be attached to the battery strap attachment point to enable the battery pack to remain attached to the portable electronic device via the strap when the battery pack is not retained within the battery compartment.

A battery pack includes an external surface that augments an external surface of a casing of a portable electronic device to cover a battery opening of a battery compartment of the portable electronic device when the battery pack is retained within the battery compartment of the portable electronic device, wherein: the battery compartment opens through the external surface of the casing at the battery opening; and the battery compartment extends into and occupies a portion of an interior volume enclosed by the casing. The battery pack also includes a battery strap attachment point configured to be attached to a strap hook of a strap, wherein: the strap comprises a first end configured to be attached to a casing strap attachment point carried on the external surface of the casing; and the strap hook is attached to a second end of the strap that is opposite the first end to enable the battery pack to remain attached to the portable electronic device through via the strap when the battery pack is not retained within the battery compartment.

1. A portable electronic device comprising:
a casing comprising:
an external surface that at least partially encloses an interior volume;
a battery compartment that occupies a portion of the interior volume and that opens through the external surface to form a battery opening; and
a casing strap attachment point carried on the external surface;
a battery pack configured to be inserted into the battery compartment through the battery opening, and to be retained within the battery compartment, wherein the battery pack comprises a battery strap attachment point; and
a strap comprising:
a first end configured to be attached to the casing strap attachment point;
a second end opposite the first end; and
a strap hook carried on the second end and configured to be attached to the battery strap attachment point to enable the battery pack to remain attached to the portable electronic device via the strap when the battery pack is not retained within the battery compartment.

2. The portable electronic device of claim 1, wherein an external surface of the battery pack augments the external surface of the casing to cover the battery opening when the battery pack is retained within the battery compartment.

3. The portable electronic device of claim 1, wherein:
the portable electronic device comprises a handheld electronic device;
the external surface of the casing forms part of a hand grip portion of the casing that is surrounded by a hand when the portable electronic device is gripped by the hand; and
when the battery pack is retained within the battery compartment, the casing strap attachment point and the battery strap attachment point are positioned to cause the strap to extend crosswise over the hand grip portion to enable the hand to be inserted between the hand grip portion and the strap to aid in securing the portable electronic device to the hand.

4. The portable electronic device of claim 1, wherein:
the strap hook is detachable from the battery strap attachment point when the battery pack is not retained within the battery compartment to enable the battery pack to be exchanged for another battery pack for use with the portable electronic device;
the battery compartment comprises a sidewall that intersects a portion of the external surface of the casing along a portion of an edge of the battery opening, and extends inward into the interior volume of the casing in an orientation that causes the sidewall to extend parallel to another surface of the battery pack when the battery pack is retained within the battery compartment;
the battery strap attachment point is positioned on a portion of the other surface of the battery pack that causes the battery strap attachment point to be positioned between the other surface of the battery pack and the sidewall of the battery compartment when the battery pack is retained within the battery compartment; and
the battery strap attachment point is configured to cooperate with the sidewall of the battery compartment to surround the strap hook to keep the strap hook from being detached from the battery strap attachment point when the battery pack is retained within the battery compartment.

5. The portable electronic device of claim 4, wherein:
the strap hook comprises a pair of tabs;
the battery strap attachment point comprises a pair of apertures that are each formed through one of a pair of opposed surfaces of the battery pack to enable each aperture to receive a corresponding tab of the pair of tabs of the strap hook; and
each tab of the pair of tabs and each aperture of the pair of apertures is configured to cooperate to form a pair of hinges that enable the strap hook to rotate relative to the battery pack.

6. The portable electronic device of claim 5, wherein each aperture of the pair of apertures is positioned at one of a pair of adjacent corners of the battery pack.

7. The portable electronic device of claim 5, wherein:
the strap hook has a generally U-shaped configuration with each tab of the pair of tabs positioned at one of the ends of the U-shape in an orientation that causes the pair of tabs to extend toward each other;
at least a portion of the strap hook comprises a flexible material that enables the U-shape to be flexed to cause the pair of tabs to be spread further apart from each other; and
the battery pack comprises a pair of chamfer surfaces with each chamfer surface of the pair of chamfer surfaces positioned adjacent one of the apertures of the pair of apertures to cooperate with portions of the ends of the U-shape of the strap hook to spread the pair of tabs further apart from each other when the strap hook is rotated relative to the battery pack to cause the ends of the U-shape to engage the pair of chamfer surfaces.

8. The portable electronic device of claim 7, wherein the strap hook is formed as a single piece of plastics material that is selected to enable the U-shape to be flexed to cause the pair of tabs to be spread further apart from each other.

9. The portable electronic device of claim 1, wherein:
the strap comprises a first patch and a second patch of a selected one of hook fasteners and loop fasteners positioned on opposite sides of the first end;
the strap comprises a third patch of the non-selected one of hook fasteners and loop fasteners positioned toward the second end;
the first end is configured to loop through the casing strap attachment point and extend back over second end to position either the first patch or the second patch adjacent to and facing the third patch to enable engagement of the hook fasteners and the loop fasteners therebetween; and
the strap is able to be lengthened or shortened by selectively positioning one of the first patch and the second patch adjacent to and facing the third patch.

10. The portable electronic device of claim 9, wherein the strap hook cooperates with the battery strap attachment point to form a hinge that enables the strap hook to rotate relative to the battery pack and relative to the external surface of the casing when the battery pack is retained within the battery compartment to enable the strap to be positioned to extend flat against the external surface of the casing regardless of whether the strap is lengthened or shortened.

11. The portable electronic device of claim 10, wherein the casing strap attachment point comprises a hinged component that rotates relative to the external surface of the casing to also enable the strap to be positioned to extend flat against the external surface of the casing regardless of whether the strap is lengthened or shortened.

12. A battery pack comprising:
an external surface that augments an external surface of a casing of a portable electronic device to cover a battery opening of a battery compartment of the portable electronic device when the battery pack is retained within the battery compartment of the portable electronic device, wherein:
the battery compartment opens through the external surface of the casing at the battery opening; and
the battery compartment extends into and occupies a portion of an interior volume enclosed by the casing; and
a battery strap attachment point configured to be attached to a strap hook of a strap, wherein:
the strap comprises a first end configured to be attached to a casing strap attachment point carried on the external surface of the casing; and
the strap hook is attached to a second end of the strap that is opposite the first end to enable the battery pack to remain attached to the portable electronic device through via the strap when the battery pack is not retained within the battery compartment.

13. The battery pack of claim 12, wherein, the battery pack further comprises:
at least one finger-operable retention hook configured to cooperate with at least one mating retention hook within the battery compartment to retain the battery pack within the battery compartment while the finger-operable retention hook is not operated to release the battery pack from the battery compartment; and
at least one fixed retention hook configured to cooperate with at least one other mating retention hook within the battery compartment to retain the battery pack within the battery compartment while the finger-operable retention hook is not operated to release the battery pack from the battery compartment.

14. The battery pack of claim 13, wherein:
the battery pack is of generally elongate shape; and
the finger-operable retention hook and the battery strap attachment point are both positioned at one end of the elongate shape.

15. The battery pack of claim 12, wherein:
the external surface of the battery pack cooperates with at least a portion of the external surface of the casing to form part of a hand grip portion of the casing that is surrounded by a hand when the battery pack is retained within the battery compartment and the portable electronic device is gripped by the hand; and
when the battery pack is retained within the battery compartment, the casing strap attachment point and the battery strap attachment point are positioned to cause the strap to extend crosswise over the hand grip portion to enable the hand to be inserted between the hand grip portion and the strap to aid in securing the portable electronic device to the hand.

16. The battery pack of claim 12, wherein:
the strap hook is detachable from the battery strap attachment point when the battery pack is not retained within the battery compartment to enable the battery pack to be exchanged for another battery pack for use with the portable electronic device;
the battery compartment comprises a sidewall that intersects a portion of the external surface of the casing along a portion of an edge of the battery opening, and extends inward into the interior volume of the casing in an orientation that causes the sidewall to extend parallel to a another surface of the battery pack when the battery pack is retained within the battery compartment;
the battery strap attachment point is positioned on a portion of the other surface of the battery pack that causes the battery strap attachment point to be positioned between the other surface of the battery pack and the sidewall of the battery compartment when the battery pack is retained within the battery compartment; and
the battery strap attachment point is configured to cooperate with the sidewall of the battery compartment to surround the strap hook to keep the strap hook from being detached from the battery strap attachment point when the battery pack is retained within the battery compartment.

17. The battery pack of claim 16, wherein:
the strap hook comprises a pair of tabs;
the battery strap attachment point comprises a pair of apertures that are each formed through one of a pair of opposed surfaces of the battery pack to enable each aperture to receive a corresponding tab of the pair of tabs of the strap hook; and
each tab of the pair of tabs and each aperture of the pair of apertures is configured to cooperate to form a pair of hinges that enable the strap hook to rotate relative to the battery pack.

18. The battery pack of claim 17, wherein each aperture of the pair of apertures is positioned at one of a pair of adjacent corners of the battery pack.

19. The battery pack of claim 17, wherein:
the strap hook has a generally U-shaped configuration with each tab of the pair of tabs positioned at one of the ends of the U-shape in an orientation that causes the pair of tabs to extend toward each other;
at least a portion of the strap hook comprises a flexible material that enables the U-shape to be flexed to cause the pair of tabs to be spread further apart from each other; and
the battery pack comprises a pair of chamfer surfaces with each chamfer surface of the pair of chamfer surfaces positioned adjacent one of the apertures of the pair of apertures to cooperate with portions of the ends of the U-shape of the strap hook to spread the pair of tabs further apart from each other when the strap hook is rotated relative to the battery pack to cause the ends of the U-shape to engage the pair of chamfer surfaces.

20. The battery pack of claim 12, wherein the strap hook cooperates with the battery strap attachment point to form a hinge that enables the strap hook to rotate relative to the battery pack and relative to the external surface of the casing when the battery pack is retained within the battery compartment to enable the strap to be positioned to extend flat against the external surface of the casing when the strap is lengthened.
